(19) United States
(12) Patent Application Publication
(10) Pub. No.: US 2013/0206063 A1
(43) Pub. Date: Aug. 15, 2013

(54) ADHESIVE APPLICATION APPARATUS AND METHODS

(71) Applicants: Pieter Terblanche Janse Van Rensburg, Glen Eagle (AU); Graeme Paul Clark, Oxenford (AU)

(72) Inventors: Pieter Terblanche Janse Van Rensburg, Glen Eagle (AU); Graeme Paul Clark, Oxenford (AU)

(21) Appl. No.: 13/572,329

(22) Filed: Aug. 10, 2012

Related U.S. Application Data
(60) Provisional application No. 61/522,946, filed on Aug. 12, 2011.

(51) Int. Cl. B05B 3/00

(52) U.S. Cl. CPC B05B 3/00
USPC 118/712; 118/300; 118/323; 118/313

(57) ABSTRACT

Adhesive application apparatus and methods are disclosed herein. An example adhesive application apparatus includes a spray assembly to apply a quantity of mixed adhesive to a designated spray area of a panel. The spray assembly has a spray boom to support a spray nozzle and an adhesive mixing chamber. The adhesive mixing chamber is coupled to the spray assembly upstream from the spray nozzle. A first fluid path provides a first adhesive component to the adhesive mixing chamber and a second fluid path provides a second adhesive to the adhesive mixing chamber.

### CROSS-REFERENCE TO RELATED APPLICATION

This patent claims the benefit of U.S. Provisional Patent Application Ser. No. 61/522,946, filed on Aug. 12, 2011, entitled “ADHESIVE APPLICATION APPARATUS AND METHODS,” which is hereby incorporated herein by reference in its entirety.

### FIELD OF THE DISCLOSURE

The present disclosure relates generally to adhesive application systems, and more particularly, to adhesive application apparatus and methods.

### BACKGROUND

Laminated panel assemblies such as, for example, structural insulated panels, are often employed in buildings and other structures. Laminated panels typically include a foam or insulated core that is disposed between outer laminated panels. In some examples, the panels may be composed of metal and the core may be composed of a foam or insulating material. A bonding agent such as an adhesive or glue is typically used to adhere or otherwise couple the outer panels to the core.

Manufacturing facilities typically employ adhesive application systems to apply the adhesive or bonding agent to the outer panels and/or the core. The outer panels are then coupled to the core and are pressed via a pressing machine to form a laminated panel assembly.

Conventional adhesive application systems often employ a drip and wiper system. A drip and wiper system typically applies or drips separate components or materials of an adhesive or bonding agent onto a laminating surface of the outer panels and/or the core, and a wiper blade oscillates across the laminating surface to mix the adhesive components together. Also, adhesive volume application rates of known systems are usually adjusted based on an operator's visual inspection. As a result, an operator may tend to apply excessive amounts of adhesive to avoid the risk of de-lamination between the panels and the core. However, with the low volume adhesive application rates needed for some applications, for example, an operator may not be able to differentiate between an adhesive application rate or adhesive spread (e.g., an amount of adhesive per area) of 80 grams/meter² and 130 grams/meter². Although both adhesive application rates may be adequate to laminate a panel assembly such as, for example, an Expanded Polystyrene (EPS) panel, there is a significant cost difference between using the different adhesive application rates. For example, the cost difference between using an adhesive application rate or spread of 80 grams/meter² and an adhesive application rate or spread of 130 grams/meter² for a production line generating EPS panels may be approximately $100,000 per year.

### BRIEF DESCRIPTION OF THE DRAWINGS

FIG. 1 illustrates an example production system configured to process a laminated panel assembly.

FIG. 2A illustrates a perspective, front view of an example adhesive application system described herein.

FIG. 2B illustrates a perspective, rear view of the example adhesive application system of FIG. 2A.

FIG. 3 is another perspective view of the example adhesive application system of FIGS. 1, 2A and 2B.

FIGS. 4A and 4B depict perspective views of an example spray assembly of the example adhesive application system of FIGS. 1, 2A, 2B and 3.

FIG. 4C is partial enlarged view of the example spray assembly of FIG. 4B.

FIG. 5A is an enlarged view of an example spray nozzle of the adhesive application system of FIGS. 1, 2A, 2B, 3 and 4A-4C.

FIG. 5B is a side view of the example spray nozzle of FIGS. 1, 2A, 2B, 3, 4A-4C and 5A.

FIGS. 5C and 5D depict another example spray nozzle described herein that may be used with the adhesive application system described herein.

FIG. 6 illustrates an example panel having an adhesive applied via the example adhesive application system of FIGS. 1, 2A, 2B, 3, 4A-4C and 5A-5D.

FIG. 7 is a block diagram of an example apparatus that may be used to implement the example adhesive application system of FIGS. 1, 2A, 2B, 3, 4A-4C and 5A-5D.

FIG. 8 illustrates a flowchart representative of an example method that may be implemented with the example adhesive application system of FIGS. 1, 2A, 2B, 3, 4A, 4B, and 5A-5D.

FIG. 9 is a block diagram of an example processor system that may be used to implement the example methods and apparatus described herein.

FIG. 10A is a perspective view of another example spray boom apparatus described herein.

FIG. 10B is a side view of the example spray boom apparatus of FIG. 10A.

FIG. 11A is another side view of the example spray boom apparatus of FIGS. 10A and 10B.

FIG. 11B is bottom view of the example spray boom apparatus of FIGS. 10A, 10B and 11A.

FIG. 12 is a cross-sectional view of the example spray boom apparatus of FIGS. 10A, 10B, 11A and 11B taken along line 12-12 of FIG. 10B.

FIG. 13 is perspective view of an example manifold apparatus of the spray boom apparatus of FIGS. 10A, 10B, 11A, 11B and 12.

FIG. 14 is a cross-sectional view of the example spray boom apparatus of FIGS. 10A, 10B, 11A and 11B taken along line 14-14 of FIG. 10B.

### DETAILED DESCRIPTION

The example adhesive application systems described herein provide a low maintenance system that may be used with panel assembly production lines (e.g., sandwich panel lines, Structural Insulated Panels (SIP) panel lines, etc.). Unlike many known adhesive application systems, the example adhesive application systems described herein can deliver a precise quantity of adhesive or an adhesive application rate to a spray area that result in significant cost savings. Also, the example adhesive application systems described herein provide a low pressure system to deliver consistent, uniform and/or evenly distributed amounts of adhesive to a spray area of a panel. Uniform delivery of precise amounts of adhesive over a spray area significantly reduces the risk of de-lamination due to voids or insufficient amounts of adhesive while preventing excessive application of adhesive to reduce costs.

The example adhesive application systems describe herein generally provide a low pressure system that can spray a bonding agent or adhesive composed from multiple different adhesive components. For example, the bonding agent may be composed of a two component polyurethane adhesive for the lamination of a core insulating material such as, for example, expanded polystyrene (EPS), mineral wool, polyurethane or polyiscoyanurate sheet, to upper and/or lower substrates including, but not limited to, pre-painted coil steel, aluminum, aluminum foil, glass reinforced plastic (GRP), cement board, Oriented Standard Board (OSB), particle board, etc.

Additionally, the example adhesive application systems described herein provide a low pressure system to prevent misting during application of the adhesive to form a laminated panel. Excessive misting may contaminate an area or environment surrounding the area in which a laminated panel is formed or manufactured. Such misting may cause damage to nearby equipment and/or products or pose health risks to operators. Unlike many known adhesive application systems, which rely on hydraulic pressure to atomize the adhesive into a spray pattern, the example adhesive application systems described herein do not use hydraulic pressure to create a spray pattern. Instead, the example adhesive application systems described herein employ a spray assembly having a pressurized air line adjacent a spray nozzle outlet to provide or improve a spray pattern of the adhesive to significantly reduce or prevent misting. As a result, for example, a spray nozzle of the spray assembly may be positioned (e.g., at a spray height or distance of) between approximately 85 millimeters and 120 millimeters relative to an area of a panel to be sprayed. In contrast, spray nozzles of known systems require at least a 300 millimeter spray height to function properly. An example spray nozzle described herein can spray pressurized air together with a quantity of adhesive at a spray rate of between approximately 240 grams/minute and 1,500 grams/minute during an adhesive application cycle.

Further, unlike many conventional systems in which an operator visually adjusts an adhesive application rate or volume, the example adhesive application systems described herein enable precise control or adjustment of an adhesive application rate or volume for a particular production run via, for example, a control system. For example, the system may automatically and continuously deliver a required or desired amount of adhesive per area (e.g., an adhesive application rate) to a spray area or surface of a laminated panel and may automatically adjust an adhesive flow rate (e.g., a mass flow rate through a spray nozzle) in response to changes in, for example, a speed of a production line to maintain a consistent and uniform adhesive application rate across the spray area. For example, with use of volumetric flow meters and an interface that detects a speed of a production line, the example system enables a user to set or input a desired adhesive coverage rate (an amount of adhesive per area) for a particular production run or panel and the system may automatically adjust the adhesive flow rate through the spray nozzle when the speed of the production line increases or decreases to provide a precise, uniform or consistent adhesive application rate across a spray area of a panel. For example, the example systems described herein can support low volume production lines that require adhesive application rates of between about 120 grams/meter² and 220 grams/meter² delivered at flow rates between about 360 grams/minute and 1,500 grams/minute. In contrast, many known systems often provide a relatively high pressure, high volume spray pattern that typically oversupplies an adhesive to a panel and, thus, are often not suitable for use with most standard, low volume production lines because these known systems cannot provide or deliver flow rates less than 750 grams/minute.

Additionally, the example systems described herein deliver a precise, proportionate mix of adhesive components. Thus, in contrast to known drip and wiper systems, the example systems described herein employ a static mixer to mix adhesive components prior to spraying on a spray area via the spray nozzle. By mixing the adhesive prior to spraying, the resultant adhesive provides greater or increased boding strength compared to adhesive mixed in the known drip and wiper systems. As a result, a smaller amount of adhesive may be applied due to the increased boding ability provided by the pre-mixed adhesive as compared to the bonding strength of the adhesive achieved via the drip and wiper method.

Additionally, the example adhesive application systems described herein employ a primed and self-cleaning system. The self-cleaning system may be automatically activated when a production line is stopped or a production run is complete. The self-cleaning system uses a cleaning agent or solvent to flush a spray nozzle and/or a mixing assembly to remove residual adhesive from the adhesive application system. As a result, no priming and no messy or time consuming clean-up is required. The example adhesive application system may also include fluid control devices (e.g., check valves) to prevent the adhesive from flowing to a spray assembly during non-use so that a spray nozzle and/or a mixing assembly remain primed and ready to start without preparation.

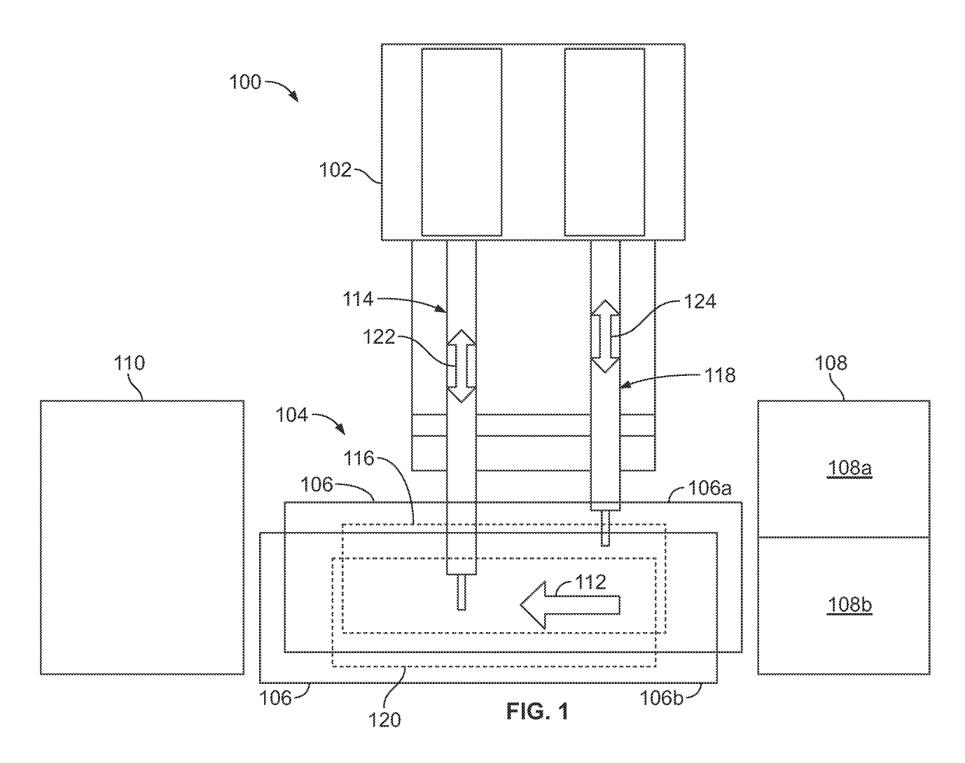

FIG. 1 is a schematic illustration of a laminated panel production system 100 configured to process a laminated panel assembly (e.g., sandwich panels, structural insulated panels (SIG's), or other composite panels) using an example adhesive application system 102 described herein. In some examples, the production system 100 may be part of a continuously moving laminating system or production line 104, which may include a plurality of subsystems that condition, prepare or deliver one or more panels 106 to the adhesive application system 102. In some examples, a subsystem may deliver a core (e.g., an insulating core) to the adhesive application system 102, which may apply an adhesive or boding agent to the core of a laminated panel assembly. In alternative examples, the adhesive application system 102 may be implemented as a standalone system.

In the illustrated example, the example adhesive application system 102 may be placed between an uncoiler assembly 108 and a subsequent operating unit 110 such as, for example, a conveyor frame and/or a panel press bed. In this example, the uncoiler assembly 108 may include a first or upper uncoiler 108a to support a first panel or skin 106a (e.g., a metal panel, a plastic panel, etc.) and a second or lower uncoiler 108b to support a second panel or skin 106b. For example, the panels 106 move from the uncoiler assembly 108, through the adhesive application system 102, and to the subsequent operating unit 110 in a direction generally indicated by arrow 112. Although not shown, one or more rollers, conveyors or guides may be used to move the panels 106 toward the adhesive application system 102. The adhesive application system 102 applies an adhesive or a bonding agent to the panels 106 as the panels 106 move toward the subsequent operating unit 110. In particular, a first spray assembly 114 of the adhesive application system 102 applies or sprays a first quantity of adhesive to a first side or designated spray area 116 (e.g., an outer surface of an inner layer or an inner surface of an outer layer) of the panel 106a and a second spray assembly 118 of the adhesive application system 102 applies a second quantity of adhesive to a second side or designated spray area 120 (e.g., an outer surface of an inner layer or an inner surface of an outer layer) of the panel 106b.

In operation, the first spray assembly 114 moves relative to the spray area 116 of the panel 106a in directions indicated by arrow 122 and the second spray assembly 118 moves relative to the spray area 120 of the panel 106b in directions indicated by arrow 124. Thus, the spray assemblies 114 and 118 move generally perpendicular relative to the direction of travel 112 of the panels 106a and 106b as the spray assemblies 114 and 118 apply or distribute an adhesive to the respective spray areas 116 and 120 of the panels 106a and 106b. The system 102 includes volumetric flow meters to measure and/or adjust a flow rate of an adhesive being applied to the spray areas 116 and 120, which may vary depending on the speed of the production line 104, to ensure that a consistent, uniform or even amount or quantity of adhesive is applied to the spray areas 116 and 120. After the adhesive is applied to the panels 106, the subsequent operating unit 110 presses the panels 106 against a core to form a laminated panel assembly (not shown). The subsequent operating unit 110 may transport the laminated panel assembly to other subsequent operating units.

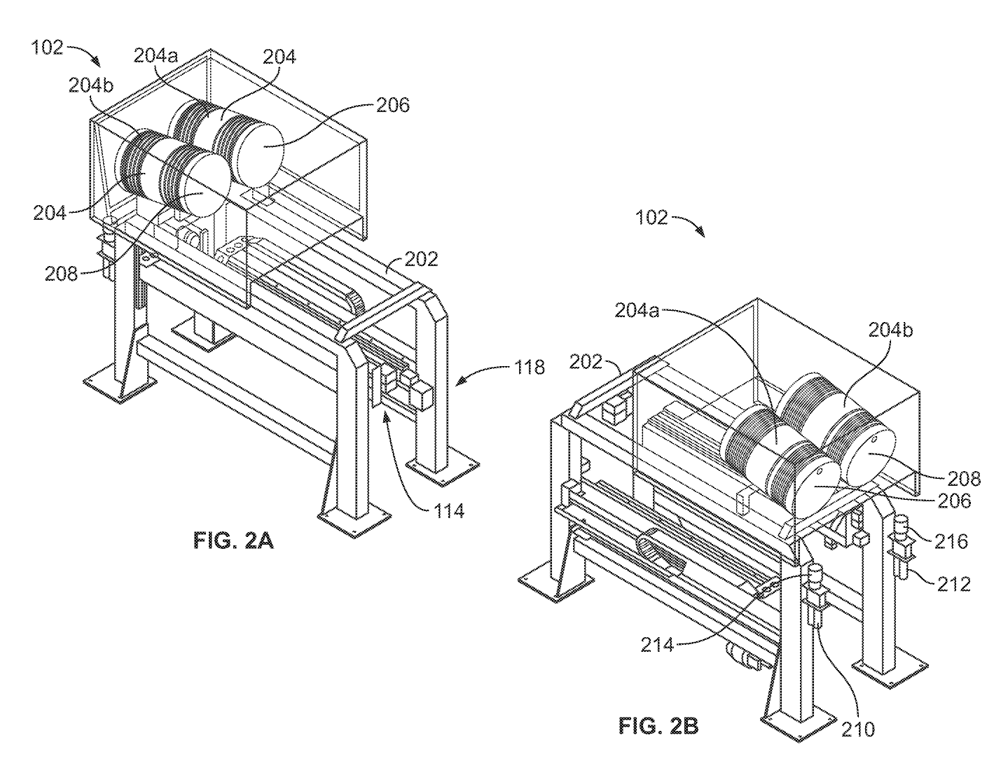

FIG. 2A is a perspective, front view of the example adhesive application system 102 of FIG. 1. FIG. 2B is a perspective, rear view of the example adhesive application system 102 of FIGS. 1 and 2A.

Referring to FIGS. 2A and 2B, the example adhesive application system 102 includes a frame 202 to support one or more adhesive or bonding agent components 204 (e.g., a two component polyurethane adhesive). In the illustrated example, the frame 202 supports a first container 206 to house a first component 204a of an adhesive and a second container 208 to house a second component 204b of the adhesive. A first pump 210 is fluidly coupled to the first container 206 to pump the first adhesive component 204a to a mixing system of each of the first and second spray assemblies 114 and 118 and a second pump 212 is fluidly coupled to the second container 208 to pump the second adhesive component 204b to the mixing system of each of the spray assemblies 114 and 118. The pumps 210 and 212 are sized to provide a proper first and second ratio mix of adhesive components 204a and 204b per a predetermined specification. In the illustrated example, the pump 210 is operated by a motor 214 (e.g., a variable speed electric motor) and the second pump 212 is operated by a motor 216 (a variable speed electric motor). The motors 214 and 216 may be operatively coupled to a variable speed drive (not shown). The frame 202 also supports the first and second spray assemblies 114 and 118.

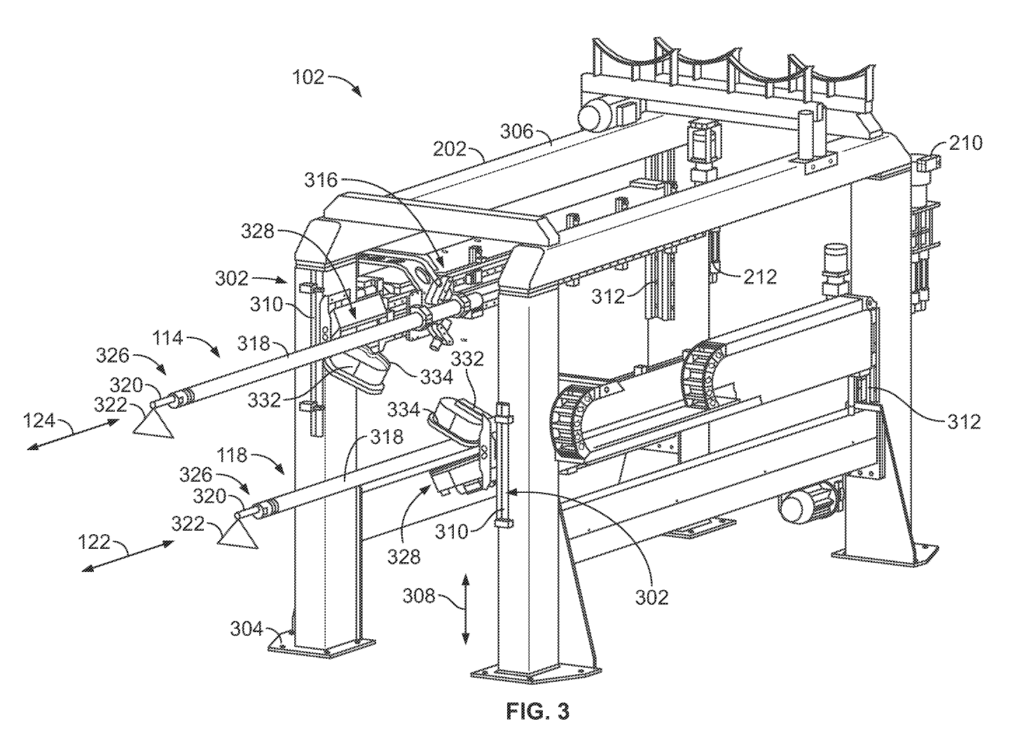

FIG. 3 illustrates a perspective view of the example adhesive application system 102 of FIGS. 2A and 2B. As shown, each spray assembly 114 and 118 is coupled to the frame 202 via an adjustment mechanism 302. The adjustment mechanism 302 enables adjustment (e.g., a vertical height adjustment) of the spray assemblies 114 and 118 relative to a lower portion 304 of the frame 202 and an upper portion 306 of the frame 202 in a direction represented by arrow 308. In this manner, the height adjustable spray assemblies 114 and 118 enable the adhesive application system 102 to adjust to different operating conditions to enable the system 102 to be retrofit or adapted to a variety of laminating production lines. In particular, because each of the spray assemblies 114 and 118 includes the adjustment mechanism 302, the first spray assembly 114 can move independently relative to the second spray assembly 118. Thus, the adjustment mechanism 302 enables the adhesive application system 102 to be used with different thickness panel productions. For example, the spray assembly 114 may be adjusted at a first height relative to the panel 106a, which can have a first thickness and a first sized spray area 116, and the spray assembly 118 may be adjusted at a second distance relative to the panel 106b, which can have a second thickness and a second sized spray area 120 different than the thickness and spray area 116 of the first panel 106a.

The adjustment mechanism 302 includes a front guide track 310 and a rear guide 312 along which the spray assemblies 114 and/or 118 can be adjusted. In this example, the adjustment mechanism 302 includes a motor (e.g., a servo motor or linear actuator) to adjust or move the spray assemblies 114 and/or 118 relative to the frame 202 in the direction of arrow 308 (e.g., a vertical direction).

To move the spray assemblies 114 and 118 in the direction of arrows 122 and 124 relative to the respective spray areas 116 and 120 of the panels 106a and 106b as shown in FIG. 1, each spray assembly 114 and 118 employs a drive system 316. Additionally, because each spray assembly 114 and 118 includes the drive system 316, the spray assembly 114 may independently move relative to the spray assembly 118. In particular, each spray assembly 114 and 118 includes a spray boom 318 that is coupled to the drive system 316 (e.g., a tooth belt drive system). The drive system 316 moves or traverses (e.g., continuously traverses) the spray boom 318 of the spray assemblies 114 and 118 over the respective spray areas 116 and 120 of the panels 106a and 106b in the direction of arrows 122 and 124. For example, the spray areas 116 and 120 can vary in distance and/or width (e.g., in the direction of arrows 122 and 124) between about 500 millimeters to 1300 millimeters. Also, the drive system 316 can move each spray boom 318 between a plurality of spraying positions across the spray areas 116 and 120 at speeds of approximately 2 meters/second. The spray boom 318 supports a spray nozzle 320, which sprays or dispenses a mixed adhesive 322 onto the spray areas 116 or 120 of the panels 106.

In operation, the pumps 210 and 212 pump the adhesive components 204a and 204b (FIGS. 2A and 2B) to the spray assemblies 114 and 118. In particular, the adhesive components 204a and 204b are pumped to the spray boom 318, which includes a mixing assembly 326 as described below. The mixing assembly 326 mixes the adhesive components 204a and 204b to provide the resultant adhesive 322, which is applied or sprayed onto the panels 106 via the spray nozzles 320. In particular, the drive system 316 may continuously move the spray boom 318 of each spray assembly 114 and 118 over the respective spray areas 116 and 120 to evenly and consistently apply a quantity or volume of the adhesive 322 to the panels 106.

Each of the spray assemblies 114 and 118 also includes a purging and cleaning system 328. Following completion of a production run, the adhesive component supply or flow from the containers 206 and 208 to the mixing assembly 326 is stopped or prevented. For example, pneumatically actuated ball valves (not shown) positioned between the pumps 210 and 212 and the mixing assembly 326 may be moved to a closed position to prevent flow of the adhesive components 204a and 204b to the mixing assembly 326. Additionally, the drive system 316 of each spray assembly 114 and 118 may retract the spray booms 318 from the production line 108 to a purging position. A purging container or receptacle 332 (e.g., a clam shell-type container) captures or closes around the spray nozzle 320 of each spray assembly 114 and 118. The purging container 328 includes a rubber gasket or seal 334 to provide a substantially tight seal around the spray nozzle 320. Thus, when an upper portion of the purging container 332 moves to closed position to engage a lower portion of the purging container 332, the gasket 334 provides a substantially tight seal to prevent fluid from escaping the purging container 332 during a purging or cleaning operation.

During a cleaning cycle, a combination of air and cleaning solvent is flushed through each spray assembly 114 and 118 and/or the spray nozzles 320 to remove any adhesive (e.g., mixed glue) from the mixing assembly 326 and/or the spray nozzles 320. Thus, the spray nozzle 320 sprays a second quantity of adhesive remaining in the mixing assembly 326 into the purging container 332. After the cleaning cycle is complete, the system 102 is primed and ready for another production run. Thus, no priming or messy or time consuming cleanup is required. The waste material is drained from the purging container 332 to a waste containment unit (not shown) via, for example, a vacuum system. After the operations of the purging and cleaning system 328 are complete, the purging container 332 moves to an open position (e.g., an upper half of the container 332 moves away from a lower half of the container 332) to release the spray nozzle 320 and/or the spray boom 318. In some examples, a controller of the system 102 may activate the purging and cleaning system 328 when the production run is complete. However, in other examples, the purging and cleaning system 328 may be activated manually by an operator.

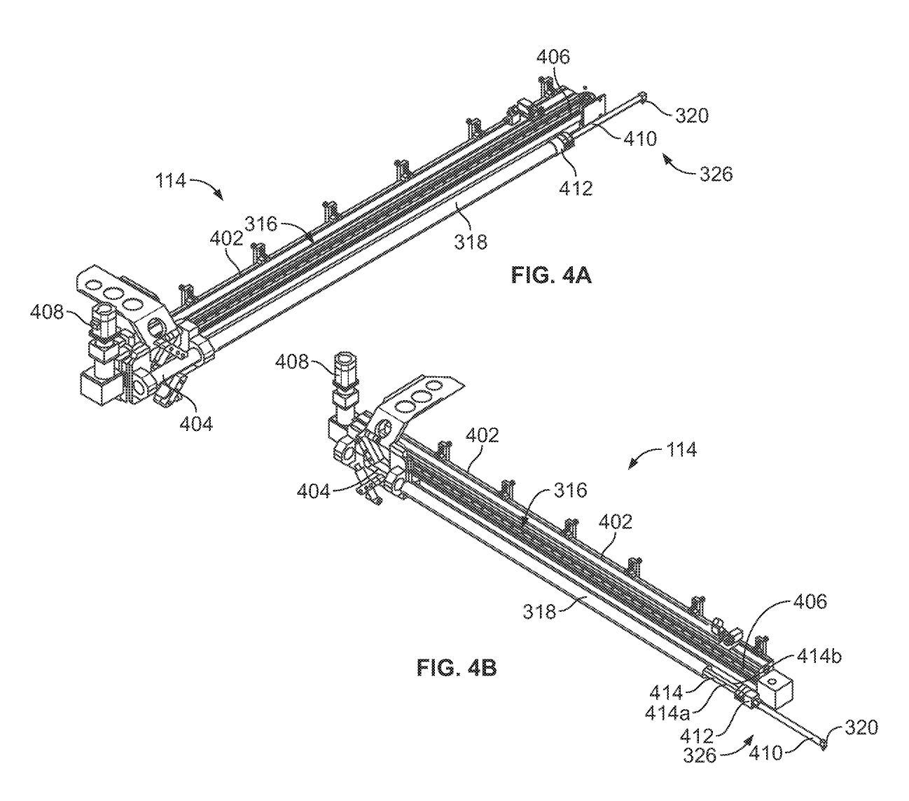

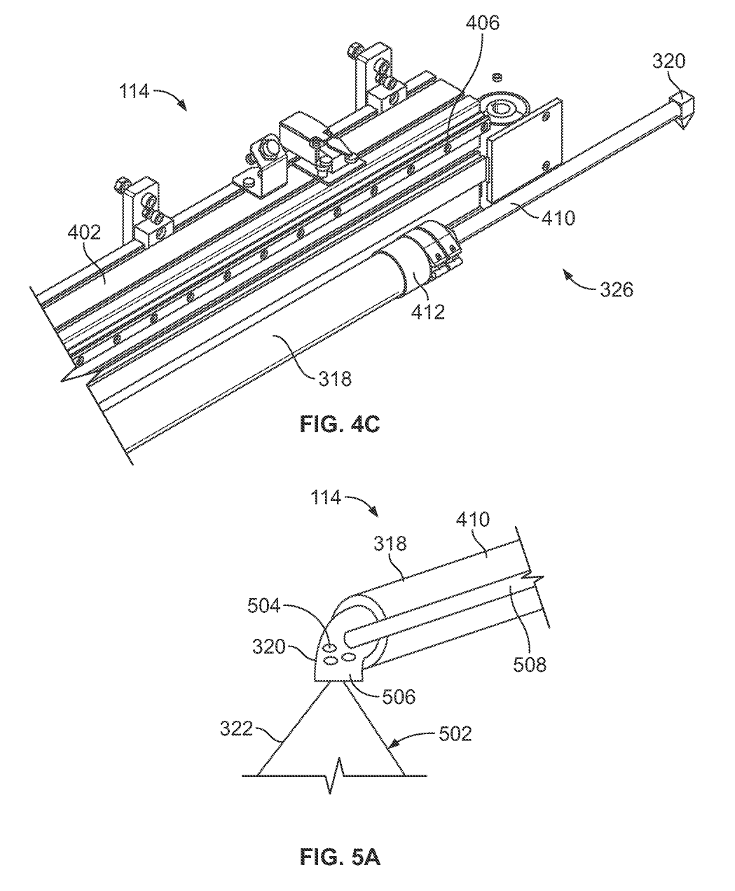

FIG. 4A is a perspective, rear view of the spray assembly 114 of FIGS. 1, 2A, 2B and 3. FIG. 4B is a perspective, front view of the spray assembly 114 of FIGS. 1, 2A, 2B 3 and 4A. FIG. 4C is an enlarged view of the spray assembly 114 of FIGS. 1, 2A, 2B, 3, 4A and 4B.

Referring to FIGS. 4A-4C, the spray assembly 114 is mounted to the frame 202 via a mounting frame 402 of the spray assembly l14. In particular, the mounting frame 402 of the spray assembly 114 is coupled to the adjustment mechanism 302 of FIG. 3 (e.g., the front and rear tracks 310 and 312). A slide or coupler 404 couples the spray boom 318 to the drive system 316. The drive system 316 of the illustrated example is a servo controlled belt drive system 406, which is operatively coupled to the spray boom 318 via the slide 404. In operation, a motor 408 drives a belt of the belt drive system 406 to move the spray boom 318 in the direction of arrow 124 via the slide 404.

As most clearly shown in FIG. 4B, the spray assembly 114 includes the spray boom 318 that supports the spray nozzle 320 and the mixing assembly 326. The mixing assembly 326 includes a spiral static mixing chamber 410 fluidly coupled to the spray nozzle 320 and a mixing chamber or head 412 (e.g., a receiving chamber) fluidly coupled to the spiral static mixing chamber 410. The mixing assembly 326 includes one or more fluid flow lines 414 that fluidly couple the mixing chamber 412 to the adhesive component containers 206 and 208 (FIGS. 2A and 2B). In this example, the spray assembly 114 includes a first fluid line 414a to carry the first adhesive component 204a to the mixing chamber 412 and a second fluid line 414b to carry the second adhesive component 204b to the mixing chamber 412. Although not shown, the fluid flow lines 414 may include one or more check valves to prevent backflow of the adhesive components 204a and 204b from the mixing chamber 412 to the containers 206 and 208. The fluid flow lines 414 are supported by the spray boom 318, which can be composed of carbon fiber, steel, aluminum or any other suitable material.

Thus, the pumps 212 and 214 pump or move the adhesive components 204a and 204b to the mixing chamber 412 of the spray assembly 114, where the components 204a and 204b are combined to begin the mixing process. The combined adhesive components 204a and 204b are then mixed in the spiral static mixing chamber 410 to form the resultant adhesive or bonding agent 322 that is sprayed on the panels 106. The mixing assembly 326 significantly improves the boding performance or strength of the adhesive 322, thereby requiring a lesser amount or volume of the adhesive 322 during the lamination process.

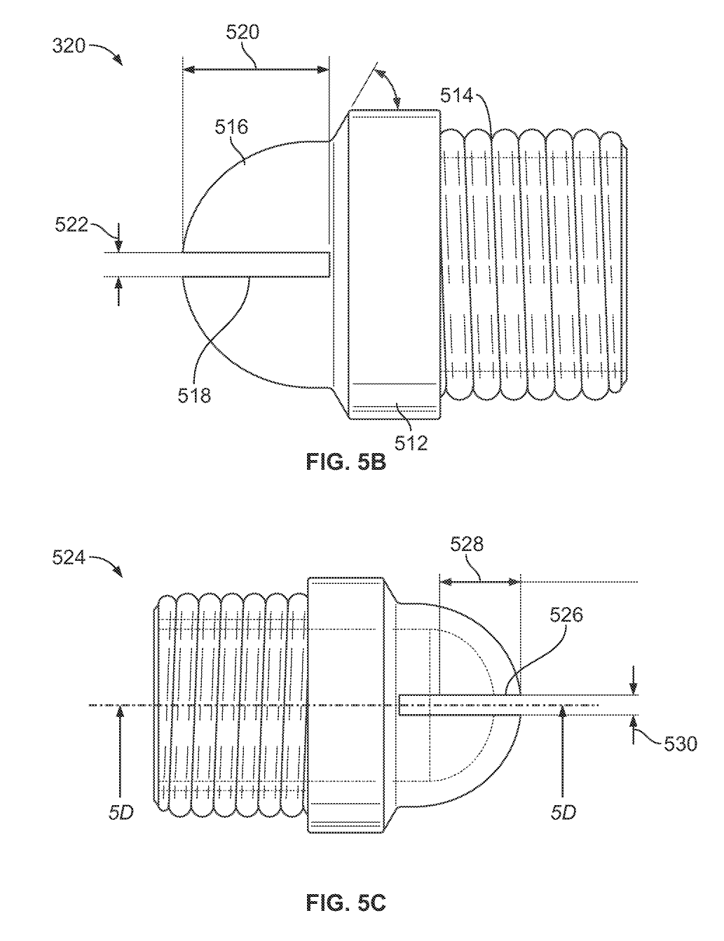

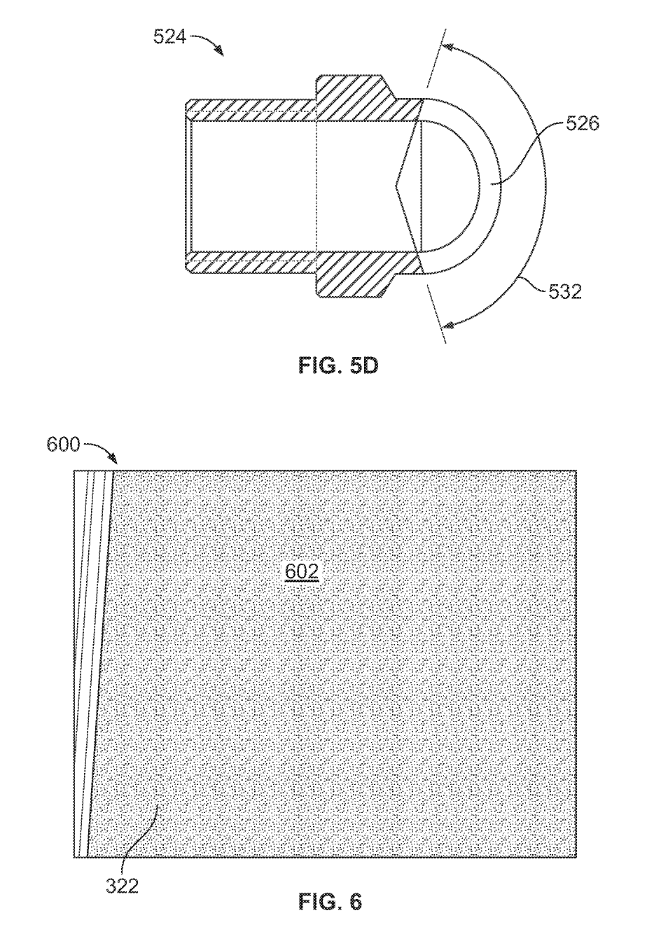

FIG. 5A depicts the spray nozzle 320 of the example spray assembly 114 of FIGS. 4A-4C. The spray nozzle 320 sprays the mixed adhesive 322 onto the spray area 120 of the panel 106b. In particular, the spray nozzle 320 provides a spray pattern 502 that significantly reduces or prevents the incidence of misting. To provide the spray pattern 502, a pressurized air flow 504 is introduced within the spray nozzle 320 adjacent a spray outlet 506 of the spray nozzle 320. In other words, the pressurized air flow 504 is introduced with the mixed adhesive 322 prior to spraying via the spray nozzle 320. For example, the pressurized air flow 504 is provided between the nozzle outlet 506 and the static spiral mixing chamber 410. More specifically, the pressurized air flow 504 is supplied adjacent the spray nozzle outlet 506 via a fluid line 508, which is supported by the spray boom 318. The air flow 504 atomizes the adhesive 322 into droplets to more effectively, uniformly or more evenly distribute the adhesive 322 via the spray nozzle 320 (or the spray nozzle outlet 506) and facilitate spraying of the adhesive 322 onto the panel 106.

Further, unlike many known systems, the spray nozzle 320 provides a low pressure, low volume spray pattern 502 that can be used with sandwich panel lamination production lines requiring relatively low adhesive application rates (e.g., less than 700 grams/meter²). As a result, the spray nozzle 320 of the example system 102 can provide low volume, adhesive application rates or adhesive spreads of between approximately 120 grams/meter² and 220 grams/meter² delivered at flow rates between approximately 360 grams/minute and 1,500 grams/minute.

FIG. 5B depicts the example spray nozzle 320 of FIGS. 3 and 5A. The spray nozzle 320 includes a body 512 having a threaded portion 514 to couple the body 512 to the spray boom 318 and a spray head 516. The spray head 516 (e.g., a round, spherical or cylindrical body) includes an opening, a cut or slot 518 to spray the adhesive 322 onto the panels 106. The slot 518 has a depth 520 and a width 522 to provide a certain flow rate range and/or the spray pattern 502. The example spray nozzle 320 may be composed of polyurethane, Teflon, metal and/or any other suitable material.

FIGS. 5C and 5D depict another example spray nozzle 524 that may be used with the spray assemblies 114 and 118. The spray nozzle 524 includes an opening or slot 526 that has a cut depth 528 and a width 530. In particular, as shown in FIG. 5D, the opening 526 that extends over an angle 532 to provide a different spray pattern than the spray pattern 502 provided by the spray nozzle 320.

FIG. 6 depicts an example panel 600 having the adhesive 322 applied via the adhesive application system 102. As shown in FIG. 6, the adhesive 322 is evenly and uniformly distributed across a designated, predetermined spray area 602 of the panel 600. Thus, unlike many known spray systems, the example adhesive application system 102 described herein provides consistent, uniform and evenly distributed amounts of the adhesive 322.

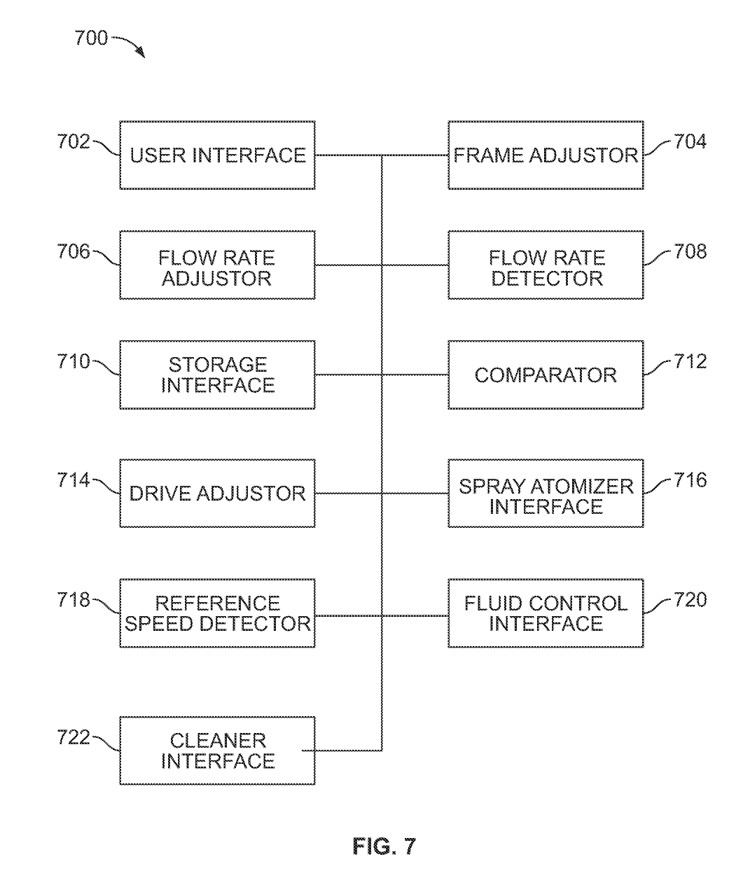

FIG. 7 is a block diagram of an example implementation of a control apparatus 700 (e.g., a closed loop control system) of the example adhesive application system 102 of FIGS. 1, 2A, 2B, 3, 4A, 4B, 5A and 5B or portions thereof. For example, the example apparatus 700 may be used to implement a feedback process to adjust the adhesive flow rates (e.g., volume or mass flow rate of the adhesive 322) during operation. Further, the example apparatus 700 may be used to implement an automated height adjustment process to adjust the position (e.g., a vertical position) of the spray nozzle 320 relative to the panels 106. Further, the example apparatus 700 may be used to implement a drive system to move or traverse the spray boom 318 relative to the spray areas 116 or 120 in the direction of the arrows 122 and 124. Additionally or alternatively, the example apparatus 700 may be used to initiate a purging or cleaning operation when a production run is complete, stopped, or otherwise not operative.

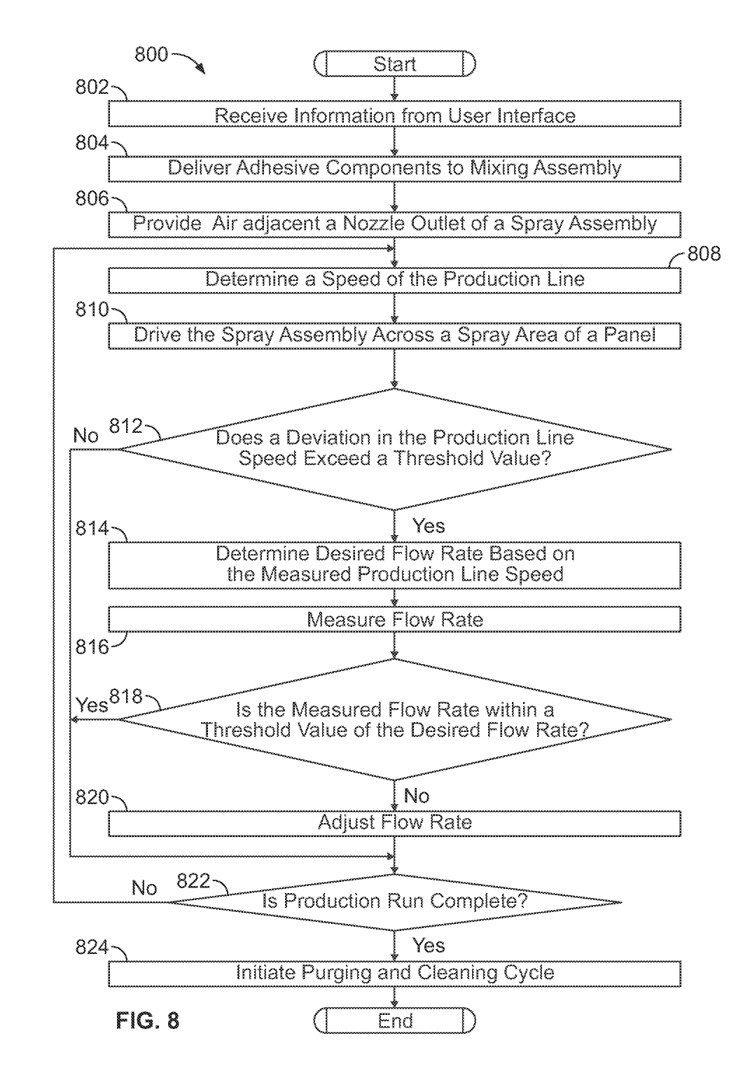

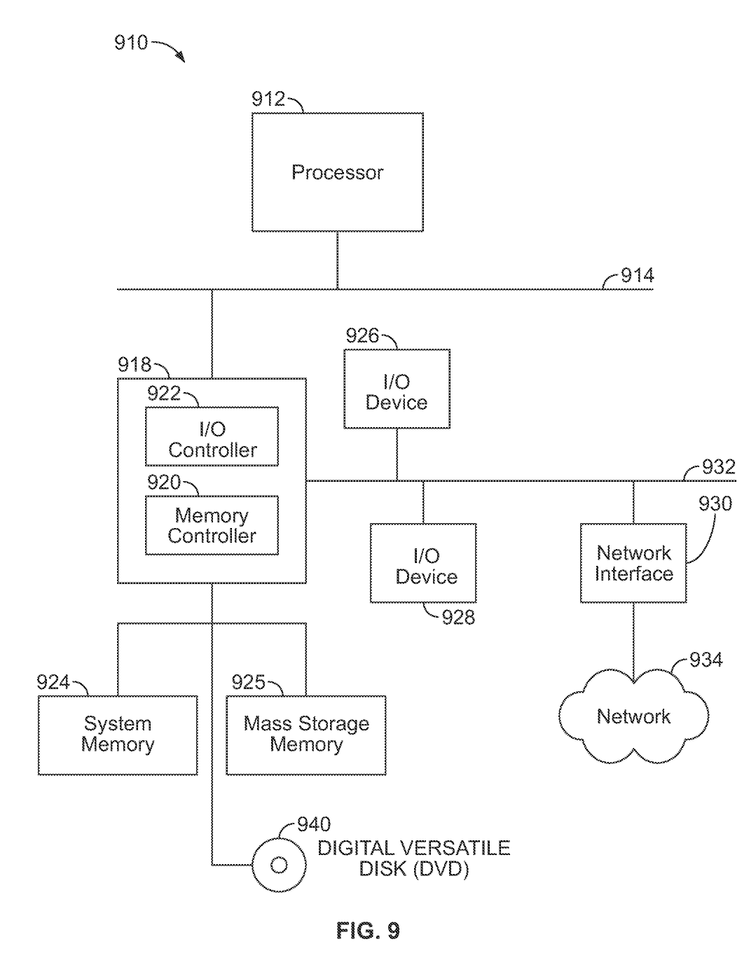

The example apparatus 700 may be implemented using any desired combination of hardware, firmware, and/or software. For example, one or more integrated circuits, discrete semiconductor components, and/or passive electronic components may be used. Additionally or alternatively, some or all of the blocks of the example apparatus 700, or parts thereof, may be implemented using instructions, code, and/or other software and/or firmware, programmable logic control (PLC), etc. stored on a machine accessible medium that, when executed by, for example, a processor system (e.g., the processor system 910 of FIG. 9) perform the methods, processes or operations represented in the flowchart of FIG. 8. Although the example apparatus 700 is described as having one of each block described below, the example apparatus 700 may be provided with two or more of any block described below. In addition, some blocks may be disabled, omitted, or combined with other blocks.

As shown in FIG. 7, the example apparatus 700 includes a user interface 702, a frame adjustor 704, a flow rate adjustor 706, a flow rate detector 708, a storage interface 710, a comparator 712, a drive adjustor 714, a spray atomizer interface 716, a reference speed detector 718, a fluid control interface 720, and a cleaner interface 722, all of which may be communicatively coupled as shown or in any other suitable manner.

The user interface 702 may be configured to receive (e.g., via user inputs) panel characteristics such as, for example, an area or size of the spray areas 116 and 120 of the panels 106a and 106b, the type of the panels 106 or core, a material of the panels 106 or core (e.g., aluminum, steel, etc.), the adhesive application rate or adhesive spread (e.g., an amount of adhesive per unit area), the speed of the production line 104, etc. For example, the user interface 702 may be implemented using a mechanical and/or graphical user interface via which an operator can input the characteristics the adhesive application rate to be applied to the spray areas 116 and 120.

The frame adjustor 704 may be configured to adjust the height or lateral (e.g., a vertical position) or lateral position of the spray nozzles 320 relative to the spray areas 116 or 120 of the panels 106a and 106b. For example, the frame adjustor 704 may be configured to obtain position values from the user interface 702 to adjust or set the lateral position of the spray nozzles 320 relative to the spray areas 116 or 120 of the respective panels 106a and 106b based on the panel characteristic(s) (e.g., the thickness of the panels 106, the material of the panels 106, the adhesive application rate, etc.). For example, the frame adjustor 704 may cause or initiate operation of the adjustment mechanism 302 to move the spray boom 318 in the direction of the arrow 308 to adjust a distance (e.g., the vertical distance) between the spray areas 116 or 120 and the spray nozzles 320.

The flow rate adjustor 706 may be configured to adjust the flow rate (e.g., a mass flow rate) of the adhesive 322 to be sprayed or dispensed by the spray nozzles 320 on the spray areas 116 or 120. The flow rate adjustor 706 may be configured to obtain the adhesive application rates (e.g., amounts of adhesive per unit area) or flow rate characteristics from the user interface 702. For example, an operator can select the adhesive application rate, adhesive spread or flow rate via the user interface 302. In some examples, the flow rate adjustor 706 may determine the flow rate value(s) by retrieving predetermined values from the storage interface 710 (e.g., via a look-up table) based on the characteristic(s) of the panels 106 and the speed of the production line 104 provided via the user interface 702.

To deliver the desired adhesive application rate, the flow rate adjustor 706 operates the pumps 210 and 212 to deliver the adhesive components 204a and 204b from the containers 206 and 208 to the mixing assembly 326 and the spray nozzles 320. To operate the pumps 210 and 212, the flow rate adjustor 706 causes or initiates operation of the motors 214 and 216, which are operatively coupled to a variable speed drive.

The flow rate detector 708 may be configured to detect a flow rate of the adhesive being sprayed or delivered to the spray areas 116 and/or 120 of the panels 106a and 106b through the spray nozzles 320. To detect the flow rate, the flow rate detector 708 may include one or more volumetric flow meters to measure the flow rate (e.g., a flow rate) of the adhesive 322 flowing through the spray nozzles 320. The flow rate detector 708 can then communicate the values measured by the volumetric flow meters to the comparator 712 and/or the storage interface 710.

The comparator 712 may be configured to compare the measured flow rates provided by the flow rate detector 708 with known calculated flow rates that provide the adhesive application rate or spread values received by the user interface 702 based on the speed of the production line. For example, if the comparison results obtained from the comparator 708 indicate that a measured flow rate provided by the flow rate detector 708 deviates by some threshold amount from the target adhesive application rate provided by the user interface 702, then the flow rate adjustor 706 adjusts (e.g., increases or decreases) flow rate of the adhesive. For example, the flow rate adjustor 706, may adjust the speed of the motors 214 and 216 that operate the pumps 210 and 212 based on the comparison results obtained from the comparator 712 to control the adhesive application rate or adhesive spread value to be substantially equal to (or within a predetermined tolerance of) the value provided by the user interface 702.

Alternatively, the flow rate adjustor 706 may adjust the flow rates of the adhesive 322 based on flow rates or adhesive application rates stored in a look-up table (not shown) in association with the characteristics of the panels 106 received from the user interface 702. The storage interface 310 may be configured to store data values in a memory such as, for example, the system memory 924 and/or the mass storage memory 925 of FIG. 9. Additionally, the storage interface 710 may be configured to retrieve data values from memory. For example, the storage interface 710 may access the data structure to obtain adhesive application rates or flow rate values per a production line speed based on the panel characteristics from the memory and communicate the values to the flow rate adjustor 706.

The drive adjustor 714 may be configured to drive or move the spray nozzles 320 via the spray booms 318 in the direction of arrows 122 and 124 relative to the spray areas 116 and 120. For example, the drive adjustor 714 may cause or initiate the motor 408 of the drive system 316 to move the spray booms 318 of the spray assembly 114 across the spray area 120 in the direction of the arrow 122 as the panel 106b moves along the production line 104 in the direction of the arrow 124. The drive adjustor 714 may cause the spray assembly 118 to move across the spray area 116 independently and/or at a different speed than the spray assembly 114.

For example, the drive adjustor 714 may receive the panel characteristic(s) from the user interface 702 and/or may receive an area of coverage or the size of the spray areas 114 and 120 from the user interface 702 and/or the storage interface 710.

The spray atomizer interface 716 may be configured to provide the pressurized air flow 504 to the spray nozzles 320. The spray atomizer interface 716 may adjust an air flow characteristic (e.g., an air flow velocity, an air pressure, etc.). For example, the spray atomizer interface 716 may adjust the amount of air and/or the air flow rate to be introduced to the spray nozzles 320 to adjust or alter the spray pattern 502 of the adhesive 322 expelled from the spray nozzles 320. For example, the spray atomizer interface 716 may cause a pump or motor (not shown) to operate to provide the desired pressurized air flow 504 within the spray nozzles 320.

The reference speed detector 718 may be configured to sense a speed of the production line 104. The reference speed detector 718 may be communicatively coupled to an encoder or speed measurement device (e.g., a sensor) that measures a reference speed value of the production line 104. For example, the reference speed detector 718 may obtain, retrieve or measure a reference speed based on the speed of the panels 106 traveling through the adhesive application system 102 (e.g., a line speed). Additionally or alternatively, the reference speed detector 718 receives a reference speed of the production line 104 from the user interface 702. Additionally or alternatively, the reference speed detector 718 may be configured to send the reference speed measurement value to the comparator 712. Additionally or alternatively, the reference speed detector 718 may then send the reference speed measurement value to the flow rate adjustor 706 and may then cause the flow rate adjustor 706 to adjust the flow rate of the adhesive 322 flowing through the spray nozzle 320 to achieve the desired adhesive application rates or adhesive spread provided by the user interface 702 and/or the storage interface 710 based on the change in the production line speed value measured by the reference speed detector 718. Thus, the system 102 can automatically adjust the adhesive flow rates through the spray nozzle 320 with changes in the speed of the production line 104 to maintain or provide a substantially consistent, uniform or even amount of adhesive on the spray areas 116 and 120.

The fluid control interface 720 may be configured to prevent flow of the adhesive components 204a and 206b to the mixing assembly 326. For example, the fluid control interface 720 may cause a fluid control device (e.g., a pneumatically controlled ball valve) to move to a closed position to prevent fluid flow between the pumps 210 and 210 and the mixing assembly 326. To determine whether the fluid control device is to move to a closed position, the fluid control interface 720 may be configured to determine if the production run is complete or the production line 104 has stopped. For example, the reference speed detector 718 may send a signal to the fluid control interface 720 to indicate that a production run is complete or stopped based the measured speed value detected by the reference speed detector (e.g., a zero speed value).

The cleaner interface 722 may be configured to prime and clean the spray nozzle 320 and/or the mixing assembly 326 of the spray assemblies 114 and 118. For example, the cleaner interface 722 may be configured to receive a signal from the reference speed detector 718 that a production run is complete or has stopped. The cleaner interface 722 may then initiate a purging and cleaning cycle. The cleaner interface 722 may send a signal to, command or otherwise cause the drive adjustor 714 to position the spray nozzle 320 within the purging container 332 (e.g., a purging position). The cleaner interface 722 may cause an upper portion of the purging container 332 to clamp against a lower portion of the purging container 332 to sealingly engage the spray nozzle 320. The cleaner interface 722 may then send a signal to control or otherwise cause a motor and/or a pump (not shown) to pump a cleaning solution or solvent through the mixing assembly 326, through the spray nozzle 320, and to a waste collection bin. The spray nozzle 320 purges a quantity of adhesive and solvent mixture remaining in the mixing assembly 326 during a cleaning cycle. The cleaner interface 722 may be configured to cause a vacuum or pump to operate to remove the waste or purged material from the purging container 332. When the cleaning or purging cycle is complete, the cleaner interface 722 causes the purging container 332 to open to release the spray nozzle 320 and sends a signal to the drive adjustor 714 that the cleaning cycle is complete.

While an example manner of implementing the adhesive application system 102 of FIGS. 1, 2A, 2B, 3, 4A-4C and 5A-5D has been illustrated in FIG. 7, one or more of the elements, processes and/or devices illustrated in FIG. 7 may be combined, divided, re-arranged, omitted, eliminated and/or implemented in any other way. Further, the example system 700, the example user interface 702, frame adjustor 704, flow rate adjustor 706, flow rate detector 708, storage interface 710, comparator 712, drive adjustor 714, spray atomizer interface 716, reference speed detector 718, fluid control interface 720, and cleaner interface 722, and/or, more generally, the example the adhesive application system 102 of FIGS. 1, 2A, 2B, 3, 4A-4C and 5A-5D may be implemented by hardware, software, firmware and/or any combination of hardware, software and/or firmware. Thus, for example, any of the example system 700, the example user interface 702, frame adjustor 704, flow rate adjustor 706, flow rate detector 708, storage interface 710, comparator 712, drive adjustor 714, spray atomizer interface 716, reference speed detector 718, fluid control interface 720, and cleaner interface 722, and/or, more generally, the example the adhesive application system 102 of FIGS. 1, 2A, 2B, 3, 4A-4C and 5A-5D could be implemented by one or more circuit(s), programmable processor(s), application specific integrated circuit(s) (ASIC(s)), programmable logic device(s) (PLD(s)) and/or field programmable logic device(s) (FPLD(s)), etc. The example adhesive application system 102 may include one or more elements, processes and/or devices in addition to, or instead of, those illustrated in FIG. 7, and/or may include more than one of any or all of the illustrated elements, processes and devices.

FIG. 8 illustrates a flowchart representative of an example method 800 for implementing the example adhesive application system 102 of FIGS. 1, 2A, 2B, 3, 4A-4C, 5A and 5B and/or the system 700 of FIG. 7. In this example, the method 800 comprises a program for execution by a processor such as the processor 912 shown in the example processing system 900 discussed below in connection with FIG. 9. The program may be embodied in software stored on a tangible computer readable medium such as a CD-ROM, a floppy disk, a hard drive, a digital versatile disk (DVD), or a memory associated with the processor 912, but the entire program and/or parts thereof could alternatively be executed by a device other than the processor 912 and/or embodied in firmware or dedicated hardware. Further, although the example program is described with reference to the flowchart illustrated in FIG. 8, many other methods of implementing the example adhesive application system 102 and/or the control system 700 may alternatively be used. For example, the order of execution of the blocks may be changed, and/or some of the blocks described may be changed, eliminated, or combined.

As mentioned above, the example process 800 of FIG. 8 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example process of FIG. 8 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

For purposes of discussion, the example method 800 of FIG. 8 is described in connection with the example system 102 and the example control apparatus 700. In this manner, each of the example operations of the example method 800 of FIG. 8 is an example manner of implementing a corresponding one or more operations performed by one or more of the blocks of the example apparatus 700 of FIG. 7.

Turning in detail to FIG. 8, initially, the user interface 702 receives input information for a production run (block 802). For example, a user may input material characteristics regarding the panels 106 (e.g., thickness, material type, etc.), the adhesive application rate or adhesive spread, spray nozzle adjustment information, an area or size of the spray areas 116 and 120, a target production line speed and/or any other information. For example, the frame adjustor 704 determines the position of the spray nozzle 320 (e.g., a vertical position) relative to the respective spray areas 116 and 120 of the panels 106a and 106b based on the input information received at block 802. For example, the frame adjustor 704 can retrieve position values from a look-up table or other data structure having start-up spray nozzle position values for different panels 106 based on, for example, material thickness, core material, spray area, etc. In other example implementations, an operator or other user can manually set the position of each spray nozzle 320 relative to the respective spray areas 116 and 120. For example, each spray nozzle 320 may be positioned between approximately 85 millimeters and 120 millimeters relative to the respective spray areas 116 or 120.

After the frame adjustor 304 adjusts of the position of the spray nozzles 320 relative to the spray areas 116 and 120, the flow rate adjustor 706 delivers the adhesive components 204a and 204b to the mixing assembly 326 (block 804). For example, the flow rate adjustor 706 provides an adhesive flow rate based on the production line speed value to deliver a first quantity of adhesive or adhesive application rate to the spray areas 116 and 120.

As the adhesive 322 moves toward the nozzle outlet 506 of the spray nozzle 320, the spray atomizer interface 716 provides the pressurized air flow 504 adjacent the nozzle outlet 506 (block 806). For example, the spray atomizer interface 716 provides the pressurized air flow 504 (e.g. pressurized air) to the nozzle outlet 506, where the air flow 504 atomizes with the mixed adhesive 322 to form the spray pattern 502. For example, the spray atomizer interface 716 may change the pressure of the pressurized air flow 504 to achieve a desired flow rate or spray pattern 502 of the adhesive 322.

During operation, the reference speed detector 718 obtains or retrieves a speed value of the production line 104 (block 808). For example, the reference speed detector 718 sends a signal or value to the comparator 712.

The drive adjustor 714 then drives the spray assemblies 114 and 118 across the respective spray areas 116 and 120 of the panels 106a and 106b to evenly and consistently apply the adhesive 322 to the spray areas 116 and 120 (block 810). For example, the drive adjustor 714 receives the production line speed from the reference speed detector 718 and/or from the user interface 702 and drives the spray booms 318 across the spray areas 116 and 120 to apply a consistent quantity of the adhesive 322 based on the speed of the production line 104. Additionally, the drive adjustor 714 may receive spray area information from the user interface 702 and/or the storage interface 710. In some examples, the drive adjustor 714 can move the spray assembly 118 across the spray area 116 independently and/or at a different speed than the speed and/or position of the spray assembly 114 moving across the spray area 120.

The reference speed detector 718 then determines if a magnitude of a difference between the measured production line speed provided at block 808 and the target production line speed value provided by the user interface 702 at block 802 exceeds a threshold value (block 812). For example, the threshold value may be a percentage (e.g., 1%, 5%, 10%, etc.) of the target production line speed value provided by the user interface 702 at block 802. For example, the comparator 712 compares the measured speed value provided by the reference speed detector 718 at block 808 with the target production line speed value provided via the user interface 702 at block 802.

If the speed reference detector 718 determines that the magnitude of the difference between the production line speed and the target speed does not exceed the threshold value at block 812, the process system 800 proceeds to block 822 (block 812).

If the measured production line speed value measured by the reference speed detector 718 exceeds the target production line speed value provided by the user interface 702 at block 802 by the threshold value (e.g., 1%, 5%, 10%, etc.) (block 812), then the flow rate adjustor 706 determines the desired flow rate based on the measured production line speed (block 814).

For example, the desired flow rate is to deliver or apply the adhesive application rate or spread received by the user interface 702 at block 802 for the given measured speed of the production line obtained at block 808. For example, the fluid flow rate adjustor 706 may determine the desired flow rate value from the storage interface 710 (e.g., a look-up table) and send the desired flow rate value to the comparator 712.

The flow rate detector 708 then measures the flow rate of the adhesive 322 through the spray nozzles 320 (block 816). For example, the fluid rate detector 708 sends a signal or value representative of a measured volumetric flow rate provided by a volumetric flow meter of the adhesive application system 102 to the comparator 712.

The flow rate adjustor 706 then determines if the measured flow rate is within a threshold value (e.g., 1%, 5%, 15%, etc.) of the desired flow rate (block 818). For example, the comparator 712 compares the measured volumetric flow rate provided at block 816 and the desired flow rate based on the measured production line speed provided at block 814.

If the flow rate adjustor 706 determines that the measured flow rate is within the threshold value of the desired flow rate, then the process 800 proceeds to block 822 (block 818).

If the flow rate adjustor 706 determines that the measured flow rate exceeds the threshold value of the desired flow rate at block 818, then the flow rate adjustor 706 adjusts the flow rate of the adhesive 322 (block 820). For example, the flow rate adjustor 706 increases or decreases the flow rate of the adhesive 322 by increasing or decreasing the speeds of the motors 214 and 216 of the pumps 210 and 212 until the flow rate detector 706 determines that the measured flow rate is within the threshold of the desired flow rate based on the measured production line speed value provided at block 808.

If the measured production line speed does not exceed the threshold value at block 812, or if the measured flow rate is within the threshold of the desired flow rate based on the measured production line speed at block 818, or after the flow rate is adjusted at block 820, then the cleaner interface 722 determines if the production run is complete (block 822).

For example, the cleaner interface 722 and/or the comparator 712 receive the measured speed value from the reference speed detector 718. If, for example, the comparator 712 determines that measured speed value of the production line 104 measured by the reference speed detector 718 is greater than a zero value, then the cleaner interface 722 determines that the production run is not complete and returns to block 808. If, for example, the comparator 712 determines that the measured speed value provided by the reference speed detector 718 is equal to a zero value, then the cleaner interface 722 determines that the production run is complete or the production line 104 is stopped.

When the production run is complete or stopped, the cleaner interface 722 initiates a purging and cleaning cycle (block 824). For example, the cleaner interface 722 may cause the drive adjustor 714 to position the spray nozzles 320 of the spray assemblies 114 and 118 within their respective purging containers 332. Also, the fluid control interface 720 moves a fluid control device to a closed position to prevent flow of the adhesive components 204a and 204b to the fluid lines 414 and/or the mixing assembly 326. The cleaner interface 722 then flushes the mixing chamber 412, the static spiral mixing chamber 410 and the spray nozzle 320 with a solvent solution. Once the cleaning cycle is complete, the cleaner interface 720 may cause the purging containers 332 to move to an open position to release the spray nozzles 320.

FIG. 9 is a block diagram of an example processor system 910 that may be used to perform the example method 900 of FIG. 8 to implement the example adhesive application system 102 and/or the control system 700 described herein.

The processor system 910 of FIG. 9 includes a processor 912 that is coupled to an interconnection bus 914. The processor 912 may be any suitable processor, processing unit, or microprocessor (e.g., one or more Intel® microprocessors from the Pentium® family, the Itanium® family or the XScale® family and/or other processors from other families). The system 910 may be a multi-processor system and, thus, may include one or more additional processors that are identical or similar to the processor 912 and that are communicatively coupled to the interconnection bus 914.

The processor 912 of FIG. 9 is coupled to a chipset 918, which includes a memory controller 920 and an input/output (I/O) controller 922. A chipset provides I/O and memory management functions as well as a plurality of general purpose and/or special purpose registers, timers, etc. that are accessible or used by one or more processors coupled to the chipset 918. The memory controller 920 performs functions that enable the processor 912 to access a system memory 924 and a mass storage memory 925, and/or a digital versatile disk (DVD) 940.

In general, The system memory 924 may include any desired type of volatile and/or non-volatile memory such as, for example, static random access memory (SRAM), dynamic random access memory (DRAM), flash memory, read-only memory (ROM), etc. The mass storage memory 925 may include any desired type of mass storage device including hard disk drives, optical drives, tape storage devices, etc. The machine readable instructions of FIG. 8 may be stored in the system memory 924, the mass storage memory 925, and/or the DVD 940.

The I/O controller 922 performs functions that enable the processor 912 to communicate with peripheral input/output (I/O) devices 926 and 928 and a network interface 930 via an I/O bus 932. The I/O devices 926 and 928 may be any desired type of I/O device such as, for example, a keyboard, a video display or monitor, a mouse, etc. The network interface 930 may be, for example, an Ethernet device, an asynchronous transfer mode (ATM) device, an 802.11 device, a DSL modem, a cable modem, a cellular modem, etc. that enables the processor system 910 to communicate with another processor system. The example network interface 930 of FIG. 9 is also communicatively coupled to a network 934, such as an intranet, a Local Area Network, a Wide Area Network, the Internet, etc.

While the memory controller 920 and the I/O controller 922 are depicted in FIG. 9 as separate functional blocks within the chipset 918, the functions performed by these blocks may be integrated within a single semiconductor circuit or may be implemented using two or more separate integrated circuits.

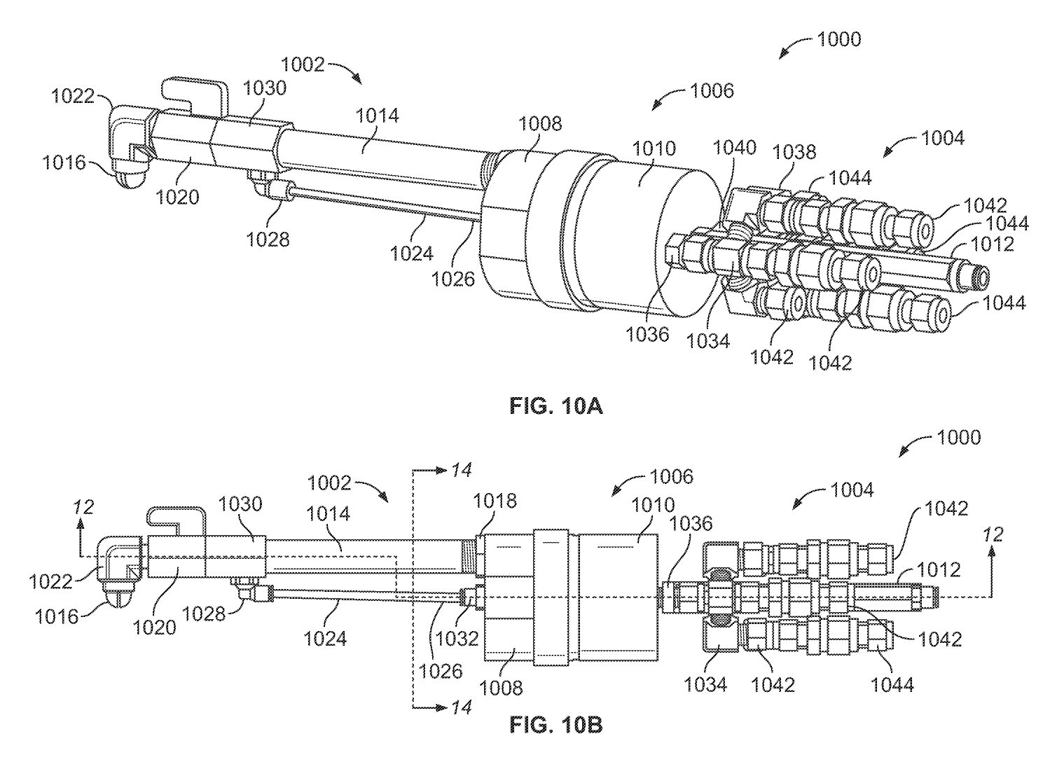

FIGS. 10A and 10B illustrate another example spray boom 1000 described herein that can be used with the spray application system 102 of FIGS. 1-9. FIG. 10A is a perspective view of the example spray boom 1000. FIG. 10B is a side view of the example spray boom 1000.

Referring to FIGS. 10A and 10B, the example spray boom 1000 includes a spray nozzle assembly 1002 and a manifold assembly 1004 coupled to a housing 1006. As shown, the spray nozzle assembly 1002 is coupled to a first portion 1008 of the housing 1006 and the manifold assembly 1004 is coupled to a second portion 1010 of the housing 1006. The spray boom 1000 of the illustrated example also includes a first fluid line 1012 (e.g., a pneumatic flow line) coupled to the second portion 1010 of the housing 1006.

The spray nozzle assembly 1002 includes a nozzle arm 1014 that couples a spray nozzle 1016 to the first portion 1008 of the housing 1006. As shown, the nozzle arm 1014 is coupled to the first portion 1008 of the housing 1006 via a fastener 1018 (e.g., a locking nut). A ball valve 1020 and an elbow 1022 couple the spray nozzle 1016 to the nozzle arm 1014 (e.g., via threads). The spray nozzle assembly 1002 also includes a second fluid line 1024 (e.g., a pneumatic line) having a first end or inlet 1026 coupled to the first portion 1008 of the housing 1006 and a second end or outlet 1028 coupled to an end 1030 of the nozzle arm 1014 adjacent the ball valve 1020. In particular, the second fluid line 1024 is adjacent (e.g., below) the nozzle arm 1014 and is coupled to the housing 1006 via a connector 1032 (e.g., a pneumatic push in connector).

The manifold assembly 1004 includes a first manifold 1034 coupled to the second portion 1010 of the housing 1006 via a connector 1036 and a second manifold 1038 coupled to the second portion 1010 of the housing 1006 via a connector 1040. The first manifold 1034 includes a plurality of fluid flow paths 1042 to fluidly couple a first adhesive component (e.g., the adhesive 204a of FIG. 2) to the housing 1006 and the second manifold 1038 includes a plurality of fluid flow paths 1044 to fluidly couple a second adhesive component (e.g., the adhesive 204b of FIG. 2) the housing 1006.

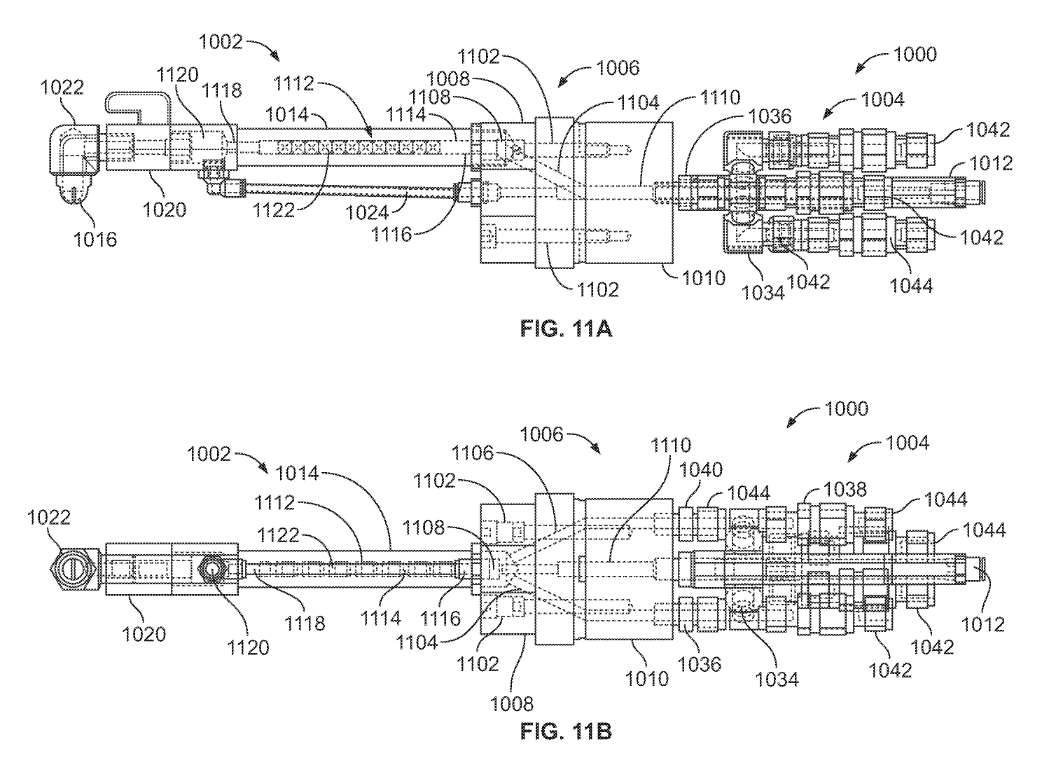

FIG. 11A is another side view of the example spray boom 1000. FIG. 11B is bottom view of the example spray boom 1000. Referring to FIGS. 11A and 11B, the housing 1006 is disposed between the spray nozzle assembly 1002 and the manifold assembly 1004. In the illustrated example, the first portion 1008 of the housing 1006 is coupled to the second portion 1010 via fasteners 1102 (e.g., cap screws). When coupled together, the housing 1006 defines one or more fluid flow passageways 1104 and 1106 to fluidly couple the manifold assembly 1004 and the spray nozzle assembly 1002. The housing 1006 also defines a mixing chamber 1108 of the spray boom 1000 that is fluidly coupled to the passageways 1104 and 1106.

Additionally, the housing 1006 defines a fluid passageway 1110 to fluidly couple the first fluid line 1012 and the second fluid line 1024. The fluid passageway 1110 is disposed adjacent (e.g., between and/or below) the passageways 1104 and 1106. Additionally, each of the passageways 1104, 1106 and 1110 defined by the housing 1006 is fluidly isolated from the other one of the passageways 1104, 1106 and 1110. In the illustrated example, the passageways 1104, 1106 and 1110 of the housing 1006 may be formed via, for example, machining, molding, and/or any other suitable manufacturing process(es).

In this example, the plurality of fluid flow paths 1042 of the first manifold 1034 are fluidly coupled or converge adjacent the connector 1036, which fluidly couples the first manifold 1034 to the first fluid flow passageway 1104 of the housing 1006. Likewise, the plurality of fluid flow paths 1044 of the second manifold 1038 converge adjacent the connector 1040, which fluidly couples the second manifold 1038 to the second fluid flow passageway 1106 of the housing 1006. The first flow passageway 1104 fluidly couples the first manifold 1034 to the mixing chamber 1108 and the second fluid flow passageway 1106 fluidly couples the second manifold 1038 to the mixing chamber 1108. Thus, adhesive components (e.g., the adhesive components 204a and 204b of FIG. 2) flow to the mixing chamber 1108 via the passageways 1104 and 1106 and the manifold assembly 1004.

The nozzle arm 1014 of the illustrated example defines a static mixer 1112 that is in fluid communication with the mixing chamber 1108 when the nozzle arm 1014 is coupled to the housing 1006. The nozzle arm 1014 is a tubular member that includes a flow path or a channel 1114 having an inlet or first end 1116 fluidly coupled to the mixing chamber 1108 and an outlet or second end 1118 fluidly coupled to an atomizing chamber 1120. In this example, the atomizing chamber 1120 is integrally formed with the nozzle arm 1014 and is adjacent the ball valve 1020. Further, the static mixer 1112 of the illustrated example includes a plurality of projections, tabs, and/or other mixing elements, patterns or profiles 1122 that mix the adhesive components into a resultant or mixed adhesive as the adhesive components flow through the channel 1114 of the nozzle arm 1014 and the static mixer 1112. For example, the projections 1122 may define a spiral shaped flow path, profile or pattern and/or any other suitable flow path or pattern to mix components of an adhesive or other fluid(s). After the adhesive components are mixed via the static mixer 1112, the resultant adhesive flows to the atomizing chamber 1120.

The atomizing chamber 1120 receives an atomizing fluid or gas (e.g., air) via the first and second fluid lines 1012 and 1024 and the passageway 1110 of the housing 1006. The atomized adhesive (e.g., the adhesive 322 of FIGS. 3 and 5) flows from the atomizing chamber 1120 to the spray nozzle 1016 via the ball valve 1020 and the elbow 1022. During operation, the spray nozzle 1016, for example, sprays the atomized adhesive onto a surface (e.g., the spray area 116 of FIG. 1).

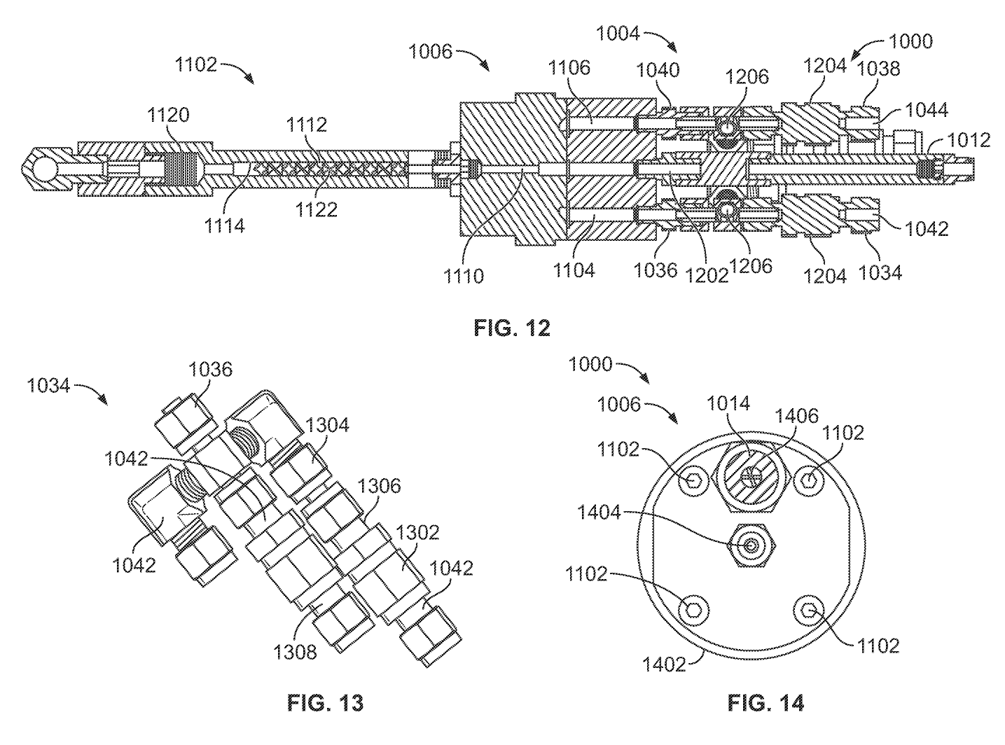

FIG. 12 is a cross-sectional view of the spray boom 1000 taken along line 12-12 of FIG. 10B. As shown in FIG. 12, the connectors 1036 and 1040 fluidly couple the respective first and second manifolds 1034 and 1038 to the respective passageways 1104 and 1106 of the housing 1006 and a connector 1202 fluidly couples the first fluid line 1012 to the passageway 1110 of the housing 1006. Additionally, each of the first and second manifolds 1034 and 1038 includes one or more valves 1204 to control fluid flow from adhesive component containers (e.g., the containers 206 and 208 of FIG. 2) to the first and second flow passageways 1104 and 1106 of the housing 1006. For example, the one or more valves 1204 may include a one-way valve to allow one-directional flow through the flow paths 1042 and 1044 of the respective manifolds 1034 and 1038. As shown, the fluid flow paths 1042 and 1044 includes one or more check valves 1206 to prevent backflow of, for example, the adhesive components 204a and 204b from the mixing chamber 1108 to the containers 206 and 208. In some examples, each flow path 1042 and/or 1044 includes a shut-off valve to prevent fluid flow through the respective flow path 1042 and/or 1044.

FIG. 13 is a perspective view of the example first manifold 1034. The first manifold 1034 is substantially similar or identical to the second manifold 1038. As noted above, the manifold 1034 includes the plurality of flow paths 1042 that are fluidly coupled or converge adjacent the connector 1036. Additionally, each flow path 1042 may include a one-way valve 1302 and/or a shut-off valve 1304. Further, a first flow line 1306 may receive a first adhesive component and a second flow line 1308 may receive a cleaning solution during a cleaning and purging process. In other examples, the fluid flow lines 1306 and 1308 receive one or more adhesive components during a spraying operation and receive a cleaning solution during a purging operation. The valves 1304 and 1306 may be moved between open and closed positions to control the flow of fluid through the flow lines 1304 and 1306.

FIG. 14 is a front view of the example spray boom 1000 taken along line 14-14 of FIG. 10B. As shown in FIG. 14, the first and second housing portions 1008 and 1010 are coupled together via the fasteners 1102 that are disposed about a periphery 1402 of the housing 1006. The second fluid line 1024 is coaxially aligned with a central axis 1404 of the housing 1006, and the mixing chamber 1108 and the nozzle arm 1014 are coaxially aligned about an axis 1406. As shown the axis 1406 is offset, and parallel, relative to the central axis 1404.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A adhesive application system comprising:
a spray assembly to apply a first quantity of mixed adhesive to a designated spray area of a panel, the spray assembly having a spray boom to support a spray nozzle and an adhesive mixing chamber, the adhesive mixing chamber being coupled to the spray assembly upstream from the spray nozzle;
a first fluid path to provide a first adhesive component to the adhesive mixing chamber; and
a second fluid path to provide a second adhesive component to the adhesive mixing chamber.

2. An adhesive application system as defined in claim 1, wherein the mixing chamber comprises a spiral static mixing chamber fluidly coupled to the spray nozzle.

3. An adhesive application system as defined in claim 2, wherein the adhesive mixing chamber further comprises a receiving chamber fluidly coupled to the spiral static mixing chamber, the receiving chamber being upstream from the spiral static mixing chamber.

4. An adhesive application system as defined in claim 2, wherein the adhesive components in the receiving chamber pass through the spiral static mixing chamber to provide the mixed adhesive.

5. An adhesive application system as defined in claim 1, wherein the first spray assembly moves generally perpendicular relative to a direction of travel of the designated spray area.

6. An adhesive application system as defined in claim 1, further comprising a volumetric flow meter to measure or adjust a flow rate of the first quantity of adhesive to the designated spray area.

7. An adhesive application system as defined in claim 1, further comprising a pressurized fluid provided to the spray nozzle upstream from a spray nozzle outlet.

8. An adhesive application system as defined in claim 7, wherein the pressurized fluid comprises pressurized air that is introduced with the mixed adhesive prior to spraying the mixed adhesive via the spray nozzle.

9. An adhesive application system as defined in claim 7, wherein the pressurized air is to atomize the mixed adhesive into droplets to distribute the mixed adhesive to the designated spray area via the spray nozzle.

10. An adhesive application system as defined in claim 7, wherein the pressurized fluid is provided via a fluid line supported by the spray boom.

11. An adhesive application system as defined in claim 1, further comprising a manifold assembly coupled to the spray boom via a housing.

12. An adhesive application system as defined in claim 11, further comprising a nozzle arm to couple the spray nozzle and the housing.

13. An adhesive application system as defined in claim 12, wherein the nozzle arm defines a spiral static mixing chamber and the housing defines a receiving chamber.

14. An adhesive application system as defined in claim 13, wherein the manifold defines the first flow path and the second flow path, the first flow path providing a first plurality of flow paths to fluidly couple the first adhesive component to the housing and the second flow path providing a second plurality of flow paths to fluid couple the second adhesive component to the housing.

15. An adhesive application system as defined in claim 14, wherein the housing defines a first passageway, a second passageway, and a third passageway, wherein the first, second and third passageways are fluidly isolated and the first and second passageways converge in the receiving chamber.

16. An adhesive application system as defined in claim 15, wherein the first plurality of flow paths is fluidly coupled to receiving chamber via the first passageway and the second plurality of flow paths is fluidly coupled to the receiving chamber via the second passageway.

17. An adhesive application system as defined in claim 15, wherein the third passageway of the housing fluidly couples a pressurized fluid to an end of the nozzle arm downstream from the spiral static mixing chamber and upstream from a spray nozzle outlet.

18. An adhesive application system comprising:
a mixing block to mix a plurality of adhesive components to form a mixed adhesive during an application cycle;
a spray nozzle in fluid communication with the mixing block, the spray nozzle to spray a first quantity of adhesive onto at least one of an outer surface of an inner layer of a structural panel or an inner surface of an outer layer of the structural panel during the application cycle; and
an atomizing chamber upstream from the spray nozzle outlet, the atomizing chamber to receive an atomizing fluid to atomize the mixed adhesive prior to exiting the spray nozzle outlet.

19. An adhesive application system as defined in claim 18, wherein the spray nozzle is to spray the first quantity of the measured adhesive at a spray rate of approximately between 240 g/min and 1500 g/min.

20. An adhesive application system as defined in claim 18, further comprising a purging receptacle to receive a second quantity of the mixed adhesive.

21. An adhesive application system as defined in claim 18, wherein the spray nozzle is to purge a second quantity of the mixed adhesive remaining in the mixing block after the application cycle.

22. An adhesive application system as defined in claim 18, further comprising a boom coupled to the spray nozzle, the boom to move the spray nozzle from one of a plurality of spraying positions to a purging position.

23. An adhesive application system as defined in claim 18, wherein the atomizing fluid comprises pressurized air, wherein the spray nozzle is to spray pressurized air together with the quantity of the mixed adhesive during the application cycle.

24. An adhesive application system as defined in claim 18, wherein the spray nozzle is to spray the first quantity of mixed adhesive at a distance of approximately between 85 mm and 120 mm from the surfaces.

25. An adhesive application system as defined in claim 18, wherein the spray nozzle is to purge a second quantity of the adhesive remaining in the mixing block by spraying pressurized air and a cleaning solvent in a purging receptacle.

26. An adhesive application system comprising:
a first spray assembly coupled to a frame, the first spray assembly to apply a first quantity of mixed adhesive to a first designated spray area of a first panel;
a second spray assembly coupled to the frame adjacent the first spray assembly, the second spray assembly to apply a second quantity of the mixed adhesive to a second designated spray area of a second panel; and
an atomizing fluid provided to each of the first and second spray assemblies, the atomizing fluid to atomize the first and second quantities of the mixed adhesive prior to the first and second quantities of the mixed adhesive being dispensed by the respective first and second spray assemblies.

27. An adhesive application system as defined in claim 26, wherein the first and second spray assemblies move generally perpendicular relative to a direction of travel of the respective first and second panels as the first and second spray assemblies apply the mixed adhesive to the respective designated spray areas.

28. An adhesive application system as defined in claim 26, further comprising a first drive to move the first spray assembly generally perpendicular relative to the designated spray area and a second drive to move the second spray assembly generally perpendicular relative to the designated spray area.

29. An adhesive application system as defined in claim 28, wherein the first drive moves independently relative to the second drive.

30. An adhesive application system as defined in claim 26, further comprising a first adjustor to adjust a lateral distance between the first designated spray area and a first spray nozzle outlet of the first spray assembly and a second adjustor to adjust a lateral distance between the second designated spray area and a second spray nozzle outlet of the second spray assembly.

31. An adhesive application system as defined in claim 30, wherein the first adjustor moves the first spray assembly independently relative to the second spray assembly.

32. An adhesive application system as defined in claim 26, further comprising a first container to hold a first adhesive component and a second container to hold a second adhesive component, the first and second containers supported by the frame.

33. An adhesive application system as defined in claim 32, further comprising a first pump fluidly coupled to the first container and a second pump fluidly coupled to the second container, the first and second pumps to pump the first and second adhesive components to respective mixing systems of the first and second spray assemblies.

34. An adhesive application system as defined in claim 33, wherein the pumps are sized to provide a ratio of the adhesive components to the mixing systems of the spray assemblies.

35. An adhesive application system as defined in claim 33, wherein each of the first and second spray assemblies comprises a spray nozzle coupled to a mixing system.

36. An adhesive application system as defined in claim 35, wherein the mixing system comprises a static spiral mixing chamber positioned between a spray nozzle outlet and a receiving chamber, the receiving chamber to receive the first and second adhesive components.

37. An adhesive application system as defined in claim 36, wherein the static spiral mixing chamber mixes the first and second adhesive components to provide the mixed adhesive prior to being atomized by atomizing fluid.

38. An adhesive application system as defined in claim 26, further comprising a first purging receptacle supported by the frame and associated with the first spray boom and a second purging receptacle supported by the frame and associated with the second spray boom.

39. An adhesive application system as defined in claim 33, wherein the first purging receptacle is to sealingly receive a first spray nozzle of the first spray assembly and the second purging receptacle is to sealingly receive a second spray nozzle of the second spray assembly such that each of the first and second purging receptacles prevents fluid from escaping the respective purging receptacles during a cleaning operation.

40. An adhesive application system as defined in claim 39, wherein, during the cleaning operation, a combination of air and solvent is flushed through the first and second spray assemblies to remove any residual adhesive in the respective spray nozzle assemblies, wherein the respective first and second purging receptacles collect the air and solvent mixture.
